(19) United States
(12) Patent Application Publication
(10) Pub. No.: US 2022/0180325 A1
(43) Pub. Date: Jun. 9, 2022

(54) METHOD OF INCREASING WORKPLACE DISABILITY INCLUSION AND SYSTEM THEREFOR

(71) Applicant: Nishith Parikh, Somerset, NJ (US)

(72) Inventor: Nishith Parikh, Somerset, NJ (US)

(21) Appl. No.: 17/448,360

(22) Filed: Sep. 22, 2021

Related U.S. Application Data
(60) Provisional application No. 62/706,430, filed on Aug. 17, 2020.

(51) Int. Cl. G06Q 10/10; G06Q 50/22; G06Q 50/20; G06F 16/951

(52) U.S. Cl. CPC G06Q 10/1053; G06Q 50/22; H04L 63/08; G06Q 10/109; G06F 16/951; G06Q 50/2057

(57) ABSTRACT

A disabled employee recruitment, disability-friendly job matching, and disability-friendly job placement system includes a client computer connected to an enterprise service center through a client portal and network. The center includes a server, a web service, a database, and a client service interface. The server receives input from the client computer; compares the received input to data stored on the database; generates a list of disability-accessible job listings or a list of disabled candidates; and transfers the list to the client computer. A method for matching a potential disabled employee with a disability-friendly job includes registering employers, prompting them to enter job data including responses to a survey; registering prospective employees and prompting them to enter employee data including responses to a survey; saving the data; comparing the employee data with the job data; generating a list of potential jobs; and transferring the list to the client computer for display.

### CROSS-REFERENCE TO RELATED APPLICATION

This application claims the benefit of priority of U.S. provisional application No. 62/706,430, filed Aug. 17, 2020, the contents of which are herein incorporated by reference.

### BACKGROUND OF THE INVENTION

The present invention relates to employment methods and, more particularly, to methods of increasing disabled employees in the workplace. Typical hiring systems do not work well when it comes to hiring people with disabilities. That is why some organizations focus only on specific components of a complex hiring ecosystem (e.g., awareness training or skills building), which increases the cost of the overall program.

Current efforts are inadequate to address the employment-related challenges of a growing population with disabilities. Fifteen percent of the global population experience some form of visible or invisible disabilities. In the US, about 55 million people, or one out of five individuals, have a visible and/or an invisible disability. Only 3 out of 10 of those individuals are employed. Moreover, 50,000 children with autism transition into adulthood each year. After the age of 18, many with special needs reach a cliff where there is very little support for them as adults. These staggering numbers indicate that adults with disabilities need improved access to employment and career development opportunities.

Ninety-three percent of companies currently employ an average of 3.2% individuals with disabilities. The government has set a 7% “utilization goal” for people with disabilities. Despite their best efforts, companies have been unable to meet this target. The most common reason is that people with disabilities tend not to self-identify at work. The low percentage of individuals who self-identify is a direct expression of how comfortable or uncomfortable they are in sharing information about their disabilities.

Mainstream or neuro-typical employees usually have limited understanding of the characteristics of Autism Spectrum Disorder (ASD) and other special needs. As a result, “hire-only” programs sans disability awareness and sensitivity training pose challenges such as workplace discrimination and bullying.

Corporate Human Resources (HR) technology systems are not configured to identify autism- or disability-friendly jobs. Once a job is identified, companies may not know where to find the right talent. Some existing methods rely on a handful of approaches driven by specific government programs to attract the right talent and fund disability inclusion training in the workplace. Other methods are based on the scope of work provided by employers. In addition, there is not enough national and global level data available to all stakeholders. These factors collectively impede the growth and expansion of disability hiring programs.

Disability hiring programs are typically initiated by Employee Resource Groups (ERGs)/Business Resource Groups (BRGs) and family members at work. This market is primarily served by healthcare and wellness service providers. In the US, there are 14,000 service providers working with the disability community. They work in local communities and are funded by government programs for job coaching and training.

To hire people with disabilities, hiring managers leverage their personal relationships with local service providers. Similarly, local providers reach out to companies and hiring managers in their neighborhoods to find jobs for their clients with disabilities. The existing systems of hiring people with disabilities are dependent on local service providers because there are no national databases of job-seeking people with disabilities.

Existing models are too expensive and limited only to pilot programs and can be used for small-scale implementations (e.g., hiring 10-15 people with disabilities). These programs are good as initiatives but are not matured enough to be part of the modern HR playbook.

Some methods offer project- and Statement of Work (SOW)-based solutions. Employment opportunities have grown manifold in other areas such as freelancing, gig, and telecommuting.

Hiring people with disabilities on a large scale is more expensive than hiring people who do not have a disability. Legal compliance is also a concern.

As can be seen, there is a need for a method to increase the number of disabled employees in the workplace.

### SUMMARY OF THE INVENTION

In one aspect of the present invention, a disabled employee recruitment, disability-friendly job matching, and disability-friendly job placement system is provided comprising; at least one client computer; and an enterprise service center comprising at least one web server, a web service for app management, a central database, and a client service interface; said enterprise service center connected to the client computer through a client portal via a network, said at least one web server configured to: receive input from the client computer via a network; validate login credentials; compare the received input to data stored on the central database wherein the central database contains disability-accessible job listings and disabled candidate resumes; generate a list of disability-accessible job listings or a list of disabled candidates; and transfer the list to said client computer via said network.

In another aspect of the present invention, a method for matching a potential disabled employee with a disability-friendly job using at least one client computer connected to at least one server via a network, posting prospective disability-friendly jobs and disability-accessible job announcements through a website is provided, comprising: providing a job platform accessible to a plurality of job seekers, hiring managers, employer administrators, university administrators, and recruiters via the internet, said job platform hosted by the at least one server; registering multiple employers for use of said website; automatically prompting each of the multiple employers to enter information into said website through a step process to create an employer profile; prompting each of the registered multiple employers to enter job data regarding prospective disability-friendly jobs including responses to an employer workplace and position survey; saving said employer profile and said job data in a database linked to said website; registering prospective disabled employees for use of said website; prompting the prospective disabled employees to enter employee data including responses to an employee workplace and position survey; saving said employee data in a database linked to said website; comparing the employee data with the job data for all job listings that have been posted by all potential employers; generating at said at least one server a list of potential jobs for the prospective disabled employees; and transferring to said client computer via said network the list of potential jobs for the prospective disabled employees for display.

These and other features, aspects and advantages of the present invention will become better understood with reference to the following drawings, description, and claims.

### BRIEF DESCRIPTION OF THE DRAWINGS

FIG. 1 is a flowchart of a method of job identification based on current and past hiring needs according to an embodiment of the present invention;

FIG. 2 is a flowchart of a method of identifying disability- and/or autism-friendly job opportunities according to an embodiment of the present invention, based on the job identification of FIG. 1;

FIG. 3A is a flowchart of a method of seeking a job according to an embodiment of the present invention;

FIG. 3B is a flowchart of a method of posting a university job according to an embodiment of the present invention;

FIG. 3C is a flowchart of a method of posting an employer job according to an embodiment of the present invention;

FIG. 3D is a flowchart of a method of posting a job request according to an embodiment of the present invention;

FIG. 4 is a flowchart illustrating a method of job seeker evaluation employing resume matching artificial intelligence (AI) according to an embodiment of the present invention;

FIG. 5 is a schematic diagram illustrating components of a system according to an embodiment of the present invention; and

FIG. 6 is a process flow diagram showing interaction of various parties of the system of FIG. 5.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a method of identifying disability-friendly jobs to create an inclusive environment while building a self-sustaining support system in the workplace for all stakeholders. The method leverages technology and follows structured processes in sequence to increase efficiency and establish a better communication system between all stakeholders.

As used herein, the phrase “all stakeholders” includes but is not limited to buddies, coaches, mentors, hiring managers, job seekers, co-workers, schools, universities, corporate HR, service providers, support teams, training teams, program teams, and veterans.

The invention focuses on building national and global databases of partners, service providers, job seekers, job coaches, and hiring companies in collaboration with HR and Procurement personnel. These databases may expand the scope of disability hiring programs in terms of both the number of locations served and the number of people placed, thereby facilitating the hiring of individuals with disabilities by connecting employers with service providers and vice versa.

The invention encompasses all aspects of talent acquisition, i.e., candidate attraction, screening, onboarding, background checks, hiring, and communication. The inventive technology framework is equipped with advanced analytics and reporting modules for performance evaluation, benchmarking, and Return on Investment (ROI) tracking. Collaboration with all stakeholders at the national level and disability awareness in the workplace by training hiring managers, supervisors, and neurotypical employees on how to work with individuals who have different abilities may result. Put differently, the invention is not limited to one or two functional areas of disability hiring.

For employers, it is a robust technology-driven solution that helps them identify roles that may be quickly filled by adhering to a well-defined and structured process while also providing existing teams with the necessary training for sensitizing them to the needs and strengths of individuals with disabilities.

For the special needs community of service providers and job seekers, the invention provides a steady flow of mainstream job opportunities in corporations that may not be readily available on the open job market. This gives job seekers a level playing field to enter the workforce and succeed.

Organizations helping the community may leverage this invention to achieve their goal of helping people with disabilities.

The invention helps create a cohesive community at work by connecting all stakeholders (constituent components) within the workplace ecosystem. For example, buddies and coaches provide mentoring and coaching, and benefit from scheduling and messaging. Hiring managers provide requisition management, interviewing, and offers, and benefit from feedback. Job seekers with a disability benefit from skills development, ongoing support, and companionship. These job seekers include individuals characterized by high-functioning neurological disorders (other than autism spectrum) and other special needs. Neurotypical/mainstream co-workers benefit from disability awareness training and communication. Schools and universities provide internships, apprenticeships, daily support, coaching, and training. Corporate HR provides onboarding and ongoing management. Service providers provide job coaching and apply for jobs on clients' behalf. The support and training team benefits from training management, scheduling, and information dissemination. The program team provides or benefits from program management, job profiling, workplace analysis, screening, assessment, and hiring management. The invention provides workforce solutions for veterans.

Similarly, the invention provides a central location for the special needs community to look for jobs that are ideal for their needs and have all the accommodations managed for them. This invention removes the guesswork for the disability community (job seekers and providers) about all aspects of employment. An easy-to-use interface with all data placed in a user-friendly manner adds to the appeal of this invention.

This invention acts as a bridge between the multiple components described herein.

Organizations may use this invention to publish job requirements without third party interaction where qualified members of the disability community and service providers get priority access. This invention has a simple and intuitive user interface.

In some embodiments, one or more features are provided from the group consisting of: Artificial Intelligence, Machine Learning, manual intervention, and sensitization coaching.

The invention is module-based, developed in-house, and custom-made for the partner organization. All components are interchangeable and configurable to deliver results. This invention may be scaled and modified to be used with segments of society that are not considered part of the traditional staffing ecosystem. For example, the invention may provide workforce solutions to veterans as well as individuals with high-functioning neurological (other than autism spectrum) special needs.

According to the inventive method, hiring needs and job requirements may be determined by a parameter selected from the group consisting of: job requirement frequency (e.g., monthly or quarterly); contract period and category; hiring ratio to the number of jobs received from client; the duration of the client's association with the organization; predicted future requirements from the client; and combinations thereof.

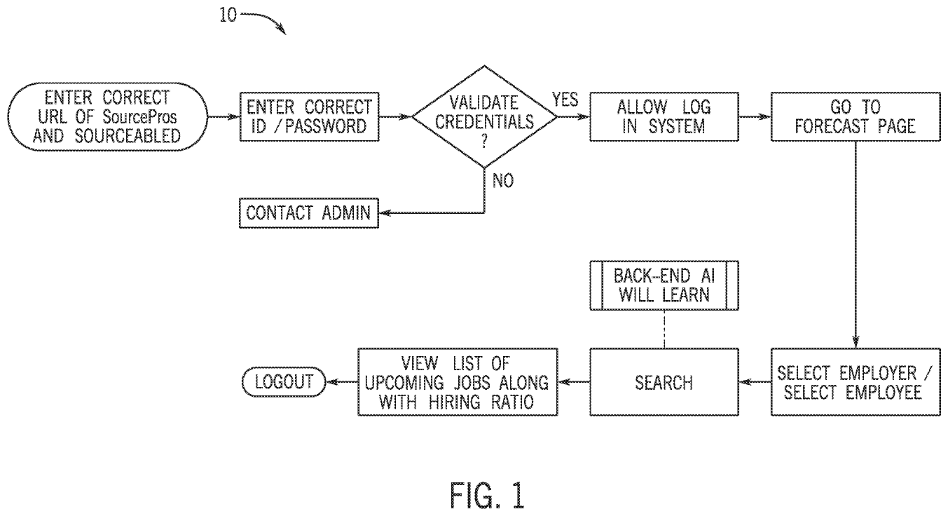

Referring to FIGS. 1 through 6, a user, such as a recruiter, may access the inventive system by logging in to a web portal by entering the correct uniform resource locator (URL) or logging into a mobile app e.g., to get the details of an upcoming requirement. The system web portal or mobile app may be referred to herein as “SourceAbled” or “SourcePros” but is not limited thereto. The system (SourcePros and SourceAbled) enables the user to login and access the system (SourcePros and SourceAbled). Generally, the user may enter the system in one of two ways. The User may login the system via social media credentials like Facebook®, LinkedIn® and Google® or the User may register in the app by providing personal information like name, number, and E-mail ID. To login, the user may enter a correct Login ID and password provided from the SourcePros and SourceAbled admin. The system (SourcePros and SourceAbled) validates the login credentials. If they are correct, the system allows the user to go forward. If they are not correct, the system directs the user to contact admin for correct Login credentials. Once the user's activities are complete, the user may logout from the system.

FIG. 1 is a flowchart 10 illustrating how jobs may be identified based on current and past hiring needs of employers. The user may select Employer/Location/Job title/time period to see a forecast with different filters. When the user clicks on the search button, artificial intelligence (AI) running in the backend analyzes criteria selected from, but not limited to, total number of jobs received since the client was on-boarded; location; hiring manager; skills; and hiring ratio. The user may see the list of upcoming jobs based upon the selected filter and display result.

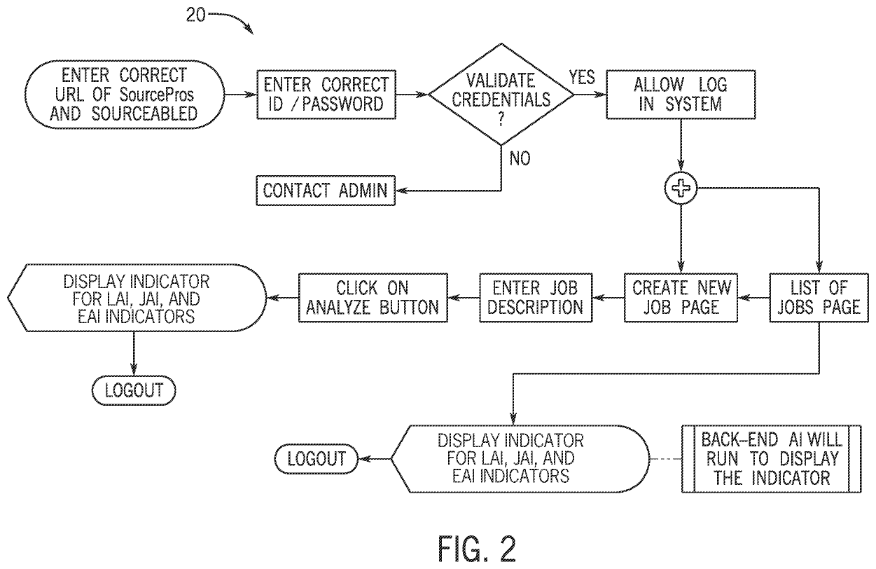

FIG. 2 is a flowchart 20 that illustrates Autism/Disability job accessibility in the SourceAbled environment. To display the indicators, an application programming interface (API) may be integrated with SourceAbled to assess the job description. The user may select “create new job” to create a new job in the system. The User may enter Job description in the box named “description” to see the indicator value. The user may click on analyze button, after entering description in the box. The backend logic which runs in the system may include, but is not limited to, the following parameters. Based upon answers to the following questions and selection of program at the time of registration, the system displays the indicators: Is HR Ready? Is workplace ready? Is hiring manager ready? Is job location ready? The system matches the entered new job description with a past job description where people on autism spectrum were hired successfully. The System displays the autism accessibility indicator (AAI), disability accessibility indicator (DAI), talent availability indicator (TAI) and neurodiversity accessibility indicator (NAI) after reading the job description entered in the description box. Location Accessibility Indicator (LAI), Job Accessibility Indicator (JAI), and Environment Accessibility Indicator (EAI) indicators may also be displayed. The system displays only those indicators for which employer has enrolled at the time of registration. The system may store the score of AAI, DAI, TAI on the training database. The user may view a list of jobs along with their respective indicators.

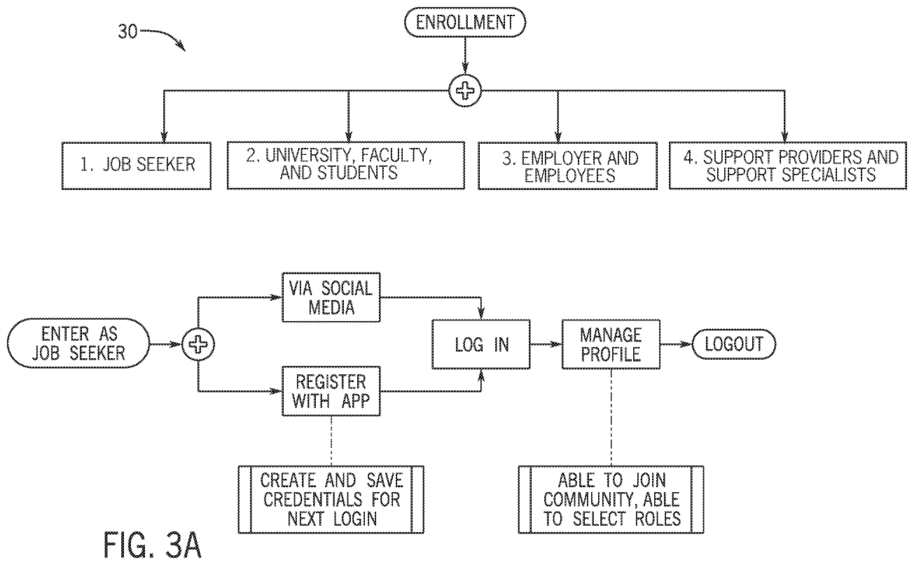

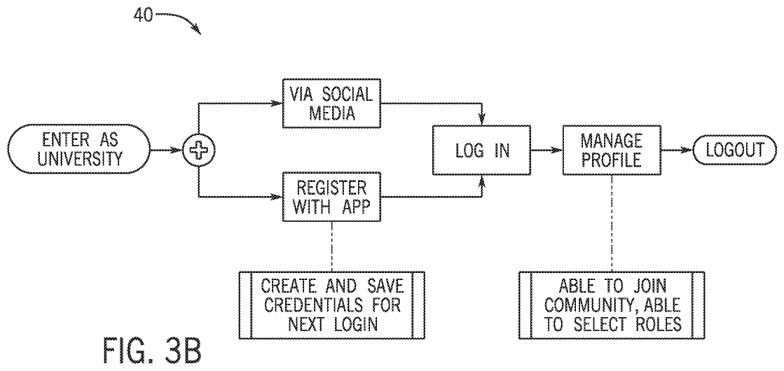

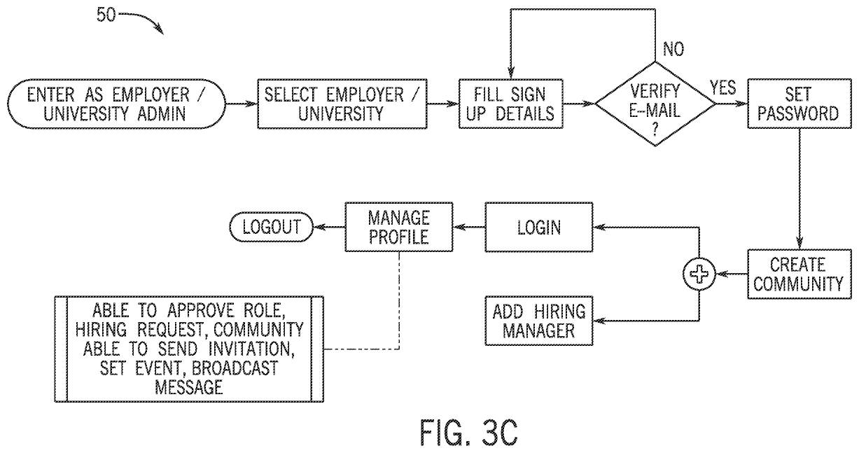

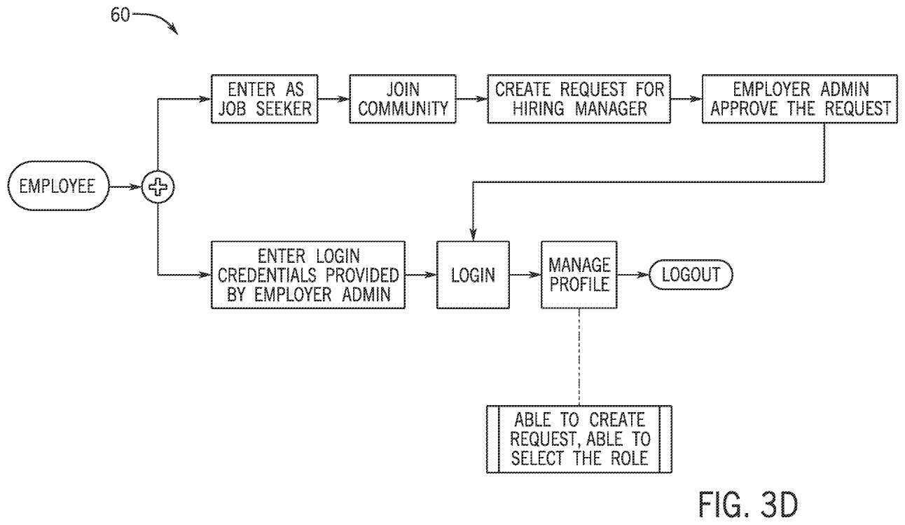

SourceAbled generally allows about 4 different types of users to enter the system: job seekers, University, faculty, and students; employers and employees; and support providers and support specialists. As shown in the flowchart 30 of FIG. 3A, the user may be a job seeker (a user who is looking for a job) and may manage their profile by performing activities which may include but are not limited to: select role; join community after hire; search and apply job; perform on-boarding; select and change job coach; edit profile; and respond to Workplace and Position Survey for job seekers. Survey responses may include: Yes, No, and Unsure. The survey may request information regarding:
1. Mobility (select from no difficulty standing; Comfortable sitting for long periods of time; Needs elevator access; and needs adjustable desk [e.g., for a wheelchair]);
2. Auditory (select from can hear clearly with no impairment; Has slight hearing impairment; Has no hearing/deaf; and can use non-verbal communication, e.g., text messages, emails, etc.);
3. Physicality (select from Can lift less than 25 lbs.; Can lift more than 50 lbs.; Can lift objects above head; Comfortable bending/twisting; Comfortable pushing/pulling objects; and Comfortable using heavy equipment);
4. Sensory (select from Comfortable working near break room, kitchen, or restroom; Comfortable working near frequently used area of the work area [e.g., hallway, conference room]; Comfortable around multiple employees; Can work within an open seating floor plan [response may be Yes, No, or With accommodation]; and Prefers being near external windows [response may be Yes, No, or No preference]). The job seeker may identify sensitivities, e.g., to fluorescent lighting; to bright/always-on lighting; to flashing or repetitive lighting (scrolling screens); to constant background noise from TVs or radios; to frequent bursts of loud noises; to varying/fluctuating temperatures; to frequent pungent smells (including heavy cologne, perfume); and/or to average noise levels. The job seeker may select a sensitivity level—None, Low, Moderate, or Severe;
5. Vision (select from Can see clearly without impairment; Have vision impairment/low vision; Have no sight/legal blindness; Needs magnifying screens; and have good hand-eye coordination)
6. Endurance (select from Can work with limited breaks; Can work at high rate of pace; Can fulfill a quota; and can complete repetitive processes);
7. Analytical and Reasoning (select from Can read above 8th grade reading level; Can recognize common shapes/symbols; Have simple mathematical skills [e.g., counting, adding, subtracting]; Have complex mathematical skills [know how to use equations e.g., y=mx+b]; and can use abstract thought and deduction);
8. Social interactions (select from Comfortable in team huddles/meetings; Comfortable in celebrations of birthdays, anniversaries, achievements; Comfortable in meetings in-person, video, or telecommunication; Comfortable with engaging coworkers for lunch and/or breaks; Comfortable with engaging coworkers in outside of work social activities; and Preference for lunch meals [e.g., select from packed lunch, buy on-site, and No preference]);
9. Common Accommodations I Need [select from Noise canceling headphones; Assigned seating; Structured schedule and breaktimes; Reduced/indirect lighting in work areas; and other accommodation(s)]; and
10. Comments (so that job seekers may add comments to clarify their needs).

FIG. 3B shows a flowchart 40 for a user who is looking for a job and is a member of a university. Activities available may include but are not limited to: select role; join community after hire; search and apply job; perform on-boarding; select and change job coach; edit profile; and, based upon the role, access selection and approval list of pages through community.

FIG. 3C shows a flowchart 50 of a University/Employer Admin explaining how he or she may enter the system. The University/Employer admin user may register themselves either as employer or as university and may fill in all the sign-up details along with E-mail ID. The System verifies the E-mail Address with workplace domain. If it is verified, the University/Employer admin user may set a password or the system may redirect to sign-up. Once a password is set, the user may create the community. The user may Login into the system in one of two ways—either create hiring manager or go directly to Login. Activities the user may perform include but are not limited to: approve roles, hiring requests, event requests and community requests; set event, send invitation, perform announcement, see jobs and applied candidates; select roles; and edit profile.

FIG. 3D is a flowchart 60 that illustrates use of the system by a Hiring manager. After getting hired by the organization, the hiring manager may join the community of the organization. The hiring manager may enroll in the system either as job seeker or by accepting an invitation mail from the employer admin to join the community and creating credentials to enter the system as hiring manager by selecting the role hiring manager and may be directed to the admin for approval. Once the admin approves the request, the hiring manager may access the system as hiring manager through the community. The activities available to the hiring manager may include but are not limited to: create request; chat with members; accept and reject events; move candidate from submission to hire; select roles; and fill Workplace and Position Survey for hiring manager. The survey may include the following:
1. Mobility (select from Required to Stand; Sitting 100%; Elevator access; and Adjustable desk);
2. Auditory (select from No impairment required; Slight hearing impairment; No use of hearing; and No-verbal communication);
3. Physicality (select from Lift less than 25 lbs.; Lift more than 50 lbs.; Lift objects above head; Bending/twisting; Pushing/pulling objects; and use of heavy equipment);
4. Sensory (select from Comfortable working near break room, kitchen, or restroom; Comfortable working near frequently used areas of the work area (hallway, conference room); Comfortable around multiple employees; Can work within an open seating floor plan [select from Yes, No, and With accommodation]; and Prefers to be near external windows [select from Yes, No, No preference]). The hiring may select any relevant sensitivities, including to fluorescent lighting; to bright/always-on lighting; to flashing or repetitive lighting (e.g., scrolling screens); to constant background noise from TVs or radios; to frequent bursts of loud noises; to varying/fluctuating temperatures; to frequent pungent smells (including heavy cologne, perfume); and/or to average noise levels. The hiring manager may respond with a sensitivity level of None, Low, Moderate, or Severe;
5. Vision (select from: See clearly without impairment; Vision impairment/low vision; No use of sight/legal blindness; Magnifying screens; and Hand-eye coordination);
6. Endurance (select from: Work with limited breaks; High rate of pace; Require a quota; and Repetitive processes completion);
7. Analytical and Reasoning (select from: Ability to read; Recognition of common shapes/symbols; Simple mathematical skills (counting, adding, subtracting); Complex mathematical skills [know how to use equations e.g., y=mx+b]; and can use abstract thought and deduction);
8. Social interactions (select from: Team huddles/meetings; Celebrations of birthdays, anniversaries, achievements; Meetings in-person, video, or telecommunication; Coworkers go to lunch and/or breaks together; Hot lunch options onsite [full cafeteria]; and Requirement/high suggestion to engage in outside of work social activities);
9. Common Accommodations Available [select from: Noise canceling headphones; Assigned seating; Designated break times; Reduced/indirect lighting in work areas; and other accommodation(s)]; and
10. Comments (Enables hiring manager to add comments to clarify their needs).

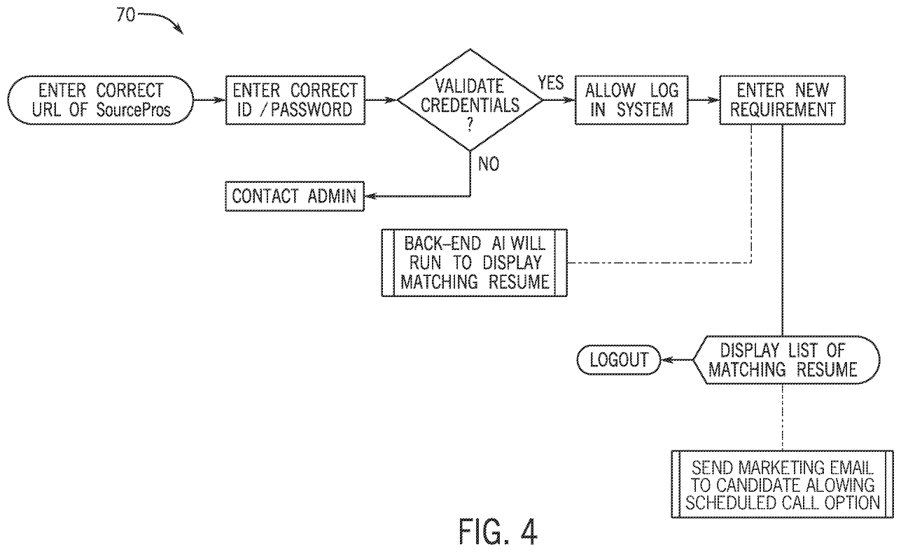

FIG. 4 shows a flowchart 70 for matching resumes for each respective job created in the system. AI runs any requirement created in the system either manually or automatically to get the matching resume. Resumes may be matched to parameters including, but not limited to: Miles; Location; Job Title; and Keywords. Auto marketing mail may be sent to a list of candidates whose resumes best match and a call may be scheduled.

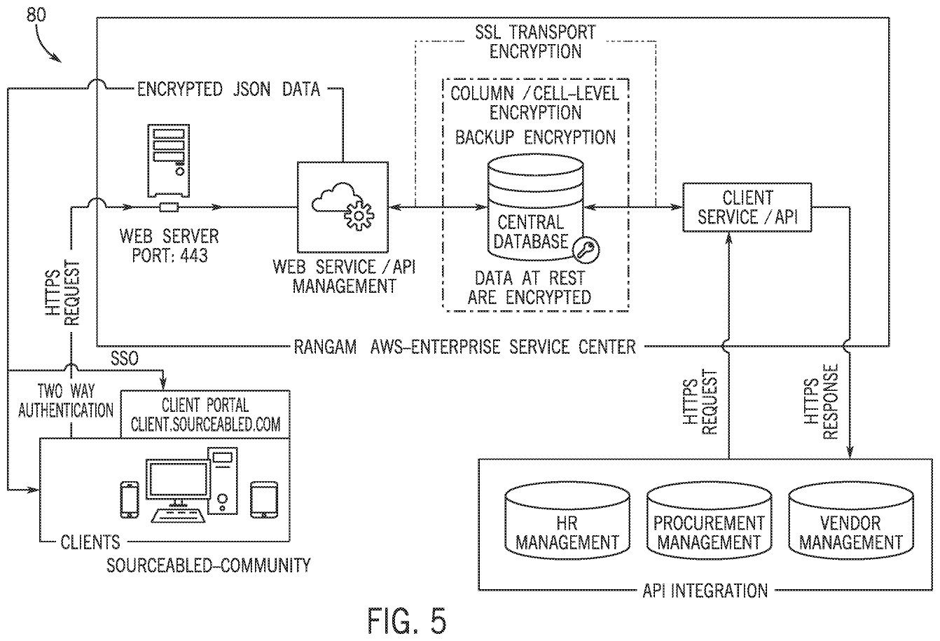

FIG. 5 is a schematic diagram 80 illustrating the components of the inventive system. Client devices may interact via a client portal with an enterprise service center comprising at least one web server, a web service for app management, a central database, and a client service interface. The client service interface interacts with the application programming interface (API) integration grouping of human resources (HR) management, procurement management, and vendor management.

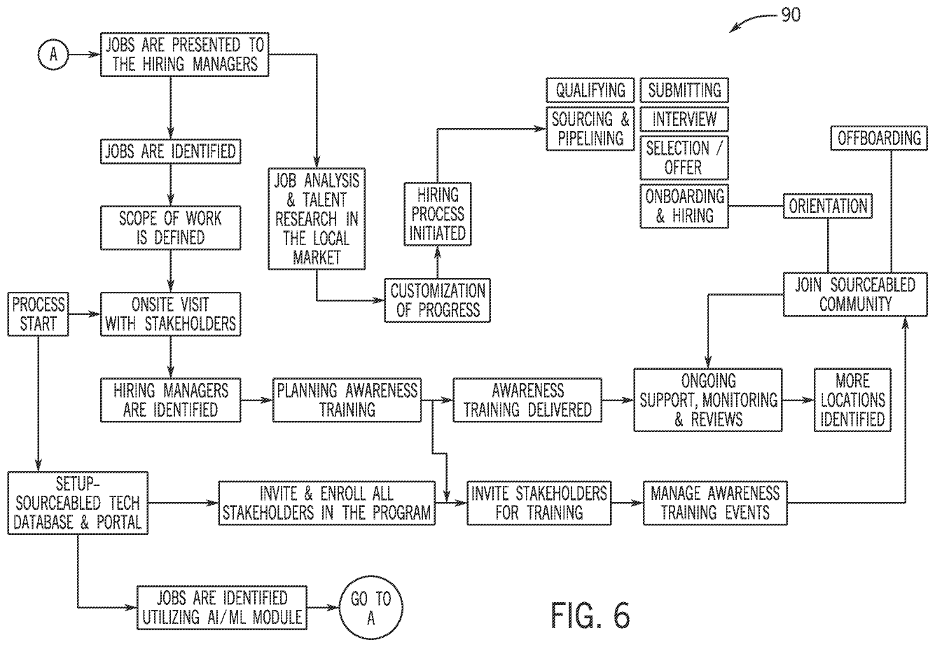

The various parties interact as shown in the process flow diagram 90 of FIG. 6. The process may start with setup of a database and portal. After an online visit, hiring managers may be identified and stakeholders may be invited to enroll and may be invited for training at awareness training events. The attendees receive ongoing support and monitoring and provide reviews, which may allow identification of additional locations. The hiring managers may plan and deliver the awareness training. Attendees may join the inventive system. A scope of work may be defined after the online visit with stakeholders, and job openings may be identified. The job identification process may use an artificial intelligence/machine learning module. The identified jobs may be presented to hiring managers. The jobs may be analyzed and research may be performed in the local market. As a result of the analysis and research, the job/prospective hire matching process may be customized. The hiring process may then be initiated, to include one or more steps selected from the group consisting of qualifying, sourcing, and pipelining, submitting, interviewing, and selection of the prospective employee/making an offer. If the offer is accepted, the process may include a step of hiring, onboarding, and orientation. If the new hire has not already joined the employer's “community”, the new hire may join. If an employee chooses to leave or is discharged, the process may also include offboarding. New disability-friendly jobs may be identified on an ongoing basis. The process may also include one or more steps selected from the group consisting of: identifying current and past hiring needs of employers; identifying champions for disability inclusion in the workplace; identifying geographic locations where the proposed method may be implemented; attracting talent in the identified geographic locations; and employees may identify their mentors.

It should be understood, of course, that the foregoing relates to exemplary embodiments of the invention and that modifications may be made without departing from the spirit and scope of the invention as set forth in the following claims.

What is claimed is:

1. A disabled employee recruitment, disability-friendly job matching, and disability-friendly job placement system comprising;
a) at least one client computer; and
b) an enterprise service center comprising at least one web server, a web service for app management, a central database, and a client service interface; said enterprise service center connected to the client computer through a client portal via a network, said at least one web server configured to:
i) receive input from the client computer via a network;
ii) validate login credentials;
iii) compare the received input to data stored on the central database wherein the central database contains disability-accessible job listings and disabled candidate resumes;
iv) generate a list of disability-accessible job listings or a list of disabled candidates; and
v) transfer the list to said client computer via said network.

2. The disabled employee recruitment, disability-friendly job matching, and disability-friendly job placement system of claim 1, wherein the enterprise service center further comprises an application program interface and/or artificial intelligence configured to forecast job openings, to match resumes with job listings, and to calculate accessibility indicators for the job listings.

3. The disabled employee recruitment, disability-friendly job matching, and disability-friendly job placement system of claim 1, wherein the at least one web server further automatically mails marketing materials to a disabled candidate whose resumes best match one of the disability-accessible job listings.

4. A method for matching a potential disabled employee with a disability-friendly job using at least one client computer connected to at least one server via a network, posting prospective disability-friendly jobs and disability-accessible job announcements through a website, comprising:
a) providing a job platform accessible to a plurality of job seekers, hiring managers, employer administrators, university administrators, and recruiters via the internet, said job platform hosted by the at least one server;
b) registering multiple employers for use of said website;
c) automatically prompting each of the multiple employers to enter information into said website through a step process to create an employer profile;
d) prompting each of the registered multiple employers to enter job data regarding prospective disability-friendly jobs including responses to an employer workplace and position survey;
e) saving said employer profile and said job data in a database linked to said website;
f) registering prospective disabled employees for use of said website;
g) prompting the prospective disabled employees to enter employee data including responses to an employee workplace and position survey;
h) saving said employee data in a database linked to said website;
i) comparing the employee data with the job data for all job listings that have been posted by all potential employers;
j) generating at said at least one server a list of potential jobs for the prospective disabled employees; and
k) transferring to said client computer via said network the list of potential jobs for the prospective disabled employees for display.

5. The method for matching a potential disabled employee with a disability-friendly job of claim 4, further comprising maintaining an online community that supports the potential disabled employees by arranging one or more support actions selected from the group consisting of mentoring; coaching; internships; apprenticeships; and training.

6. The method for matching a potential disabled employee with a disability-friendly job of claim 4, wherein the server is configured to analyze the job data and calculate accessibility indicator values for each potential job and display the accessibility indicator values on the list of potential jobs.

7. The method for matching a potential disabled employee with a disability-friendly job of claim 4, further comprising prompting the prospective disabled employee to apply for at least one of the potential jobs.

8. The method for matching a potential disabled employee with a disability-friendly job of claim 4, further comprising analyzing a workplace for disability-accessibility readiness.

9. The method for matching a potential disabled employee with a disability-friendly job of claim 4, further comprising analyzing the potential jobs for disability-accessibility readiness.

10. The method for matching a potential disabled employee with a disability-friendly job of claim 4, further comprising forecasting disability-friendly jobs.

11. The method for matching a potential disabled employee with a disability-friendly job of claim 4, further comprising automatically mailing marketing materials to potential employees.

12. The method for matching a potential disabled employee with a disability-friendly job of claim 4, further comprising hiring one of the prospective disabled employees comprising one or more step selected from the group consisting of: screening the prospective disabled employee; scheduling calls between a potential employer and the prospective disabled employee; scheduling and holding interviews between the potential employer and the prospective disabled employee; making an offer to the prospective disabled employee; onboarding the prospective disabled employee; and orienting the prospective disabled employee.

13. The method for matching a potential disabled employee with a disability-friendly job of claim 4, further comprising scheduling awareness training events and conducting disability awareness and sensitivity training.
